(19) United States
(12) Patent Application Publication
(10) Pub. No.: US 2005/0100290 A1
(43) Pub. Date: May 12, 2005

(54) Low Profile Optoelectronic Package

(75) Inventor: Rong Huang, Westborough, MA (US)

Correspondence Address: Rong Huang, 293 Turnpike Rd, Suite 219, Westborough, MA, 01581, US

(73) Assignee: rong huang, Westborough, MA (US)

(21) Appl. No.: 10/709,968

(22) Filed: Jun. 9, 2004

Related U.S. Application Data
(60) Provisional application No. 60/518,017, filed on Nov. 6, 2003.

(51) Int. Cl. G02B 6/36

(52) U.S. Cl. 385/92; 385/88

(57) ABSTRACT

A low profile optoelectronic package is provided. The thermal electrical coolers are mounted on the sidewalls of the package box. The sides of the platform on which optical components are disposed are attached on the top surface of the thermal electrical coolers. The overall height of the package is reduced. For an open bottom package box, the platform can be accessed from the bottom.

### CROSS REFERENCE To RELATED APPLICATIONS

This applicaion claims the benefit of the priority date of Provisional Patent Application No. 60/518,017, filed Nov. 6, 2003.

### BACKGROUND OF INVENTION

1. Field of the Invention

The present invention relates to optical components and, more particularly to packaging optoelectronic devices, such as laser diodes, detectors and MEMS device, which need thermal electrical cooler to actively adjust their operating temperature.

2. Background

Optoelectronic devices, such as laser diodes and semiconductor detectors are widely used in optical communication systems, sensing systems and other systems that needs light sources or light detectors or both. These devices are very sensitive to the environmental temperature fluctuation and usually, their temperature is actively adjusted. To achieve the temperature control, a thermal electrical cooler (TEC) is usually used.

The optoelectronic devices are also sensitive to the moisture or other contaminants that degrade their performance. To avoid the moisture and contaminants, the devices are hermetically sealed in a box which usually has optical connector(s) to allow optical fiber(s) to be connected from the outside to the inside devices and electrical leads to feed (or take) electrical power to (or from) the devices and other components, such as TEC, as one illustrated in FIG. 1.

Usually, the package box is a dual in-line package or butterfly package. The dual in-line package has electrical leads on the bottom of the package and optical fiber connector on its sides. The butterfly package has electrical leads and optical connector(s) on its sides, as exampled in FIG. 1.

The method to package the opto-electronic devices in prior arts, as one shown in the FIG. 1 is to attach a TEC on the bottom of the package and then a platform, which carries components (not shown here) that need active temperature control or other components, such as optical lens, thermistor and optical alignment holders (not shown here), sits on the top of the TEC. The platform may has pattern on it to facilitate the electrical connection or packaging alignment.

If TEC sitting on the bottom of the package box, the bottom not only supports the TEC and platform on it, but also acts as thermal sink. Usually, the bottom is more than 1 mm thick. The short coming of the conventional packages of the platform sitting on the TEC is the increase of the overall package height, which is limited in some situations. The package is finally mounted on a circuit board. Each type of component incorporated into a circuit board is miniaturized and has a low profile structure, thereby creating a demand for optoelectronic package modules to have a thin construction, too. The second is that the platform is fixed height relative to the TEC, which limits its vertical adjustment, which could be used to align the optical path of the devices on the platform to the optical fiber in some cases, in which the output optical fiber is not fixed on the platform.

Therefore, there is a need of a package with low profile and a platform can-be vertically adjusted. This invention discloses by attaching TEC(S) to the sides of a package box and the side(s) of a platform to the top of the TEC to reduce the overall package height and allow the platform vertically being adjusted or even slightly tilted relative to the TEC(s).

### SUMMARY OF INVENTION

There is provided in accordance with the present invention a method for mounting thermal electrical cooler(s) to a packaging box and attaching platform(s) to the thermal electrical cooler(s) to reduce the overall package height. An exemplary embodiment of the present invention also provides an opto-electronic package with lower profile compared to existing package. The package is generally rectangular. The overall package consists of a package box, which has four sides and an open bottom or a close bottom, thermal electrical cooler(s) and platform(s) on which opto-electrical components are mounted on.

The package box has electric leads on its sidewalls, as in butterfly package or bottom, as in dual in-line package and optical fiber connector(s) on its side walls. The bottom of the TEC(S) is attached to the sidewall(s) of the package by epoxy or solder. Then, the side of the platform is attached to the top of the TEC(s). The package may also have radio frequency connector on its sidewalls.

If the package body have an open bottom, the platform can be accessed from both the top and bottom of the package.

As the way of aligning the platform to the TEC(s), the platform could be moved vertically or rotated relatively to the TEC(s) before being fixed by epoxy or solder. After packaging, the package body is seam-sealed.

Comparing to convention package, the package height is reduced by the thickness of the TEC and the most thickness of the package bottom.

It is to be understood that both the forgoing general description and the following detailed description are exemplary, but are not restrictive, of the invention.

### BRIEF DESCRIPTION OF DRAWINGS

The invention is best understood from the following detailed description when read in connection with the accompanying drawings. It is emphasized that, according to common practice, the various features of the drawing are not to scale. On the contrary, the dimensions of the various features are arbitrarily expanded or reduced for clarity. Included in the drawing are the following figures:

FIG. 1 is an illustration of conventional packaging sequence with a “butterfly” package box.

FIG. 2 shows that two TECs are attached to the two opposite sides of a package box.

FIG. 3 illustrates an exemplary platform.

FIG. 4 shows a laser diode package in which the two sides of the platform attached to the TECS.

FIG. 5 illustrates the section view of the platform attached to the TECS.

FIG. 6 shows another diode laser package with electrical leads on the same sides of the TECS.

FIG. 7 shows a dual in-line package box with two TECs attached on the sides of the box and the package box has an open bottom.

FIG. 8 illustrates a package with two TECs on adjacent sidewalls, the platform has L-shape shoulder, and a radio frequency connector mounted on the side of the box for high frequency application.

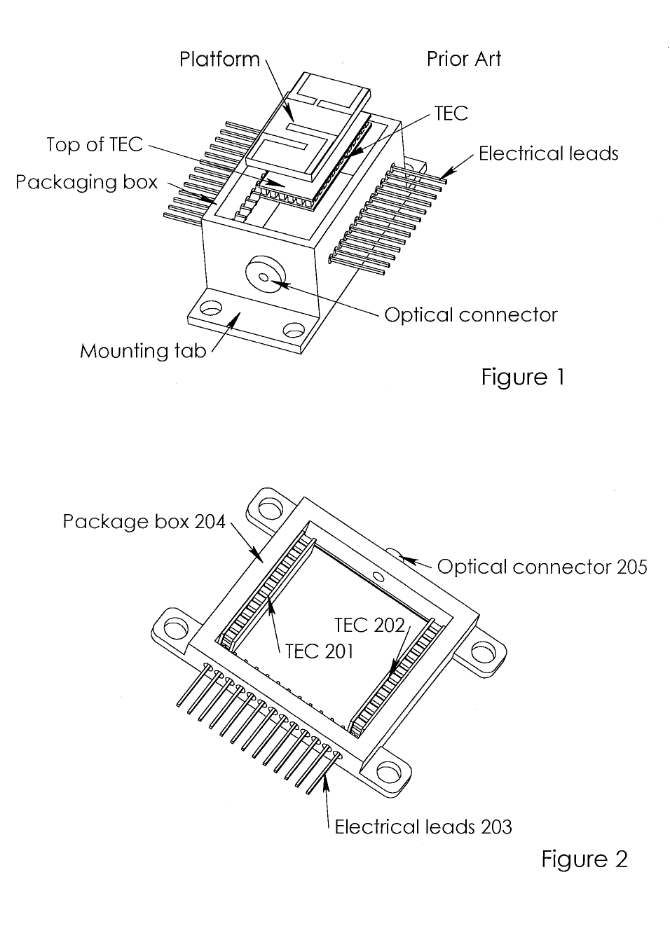

### DETAILED DESCRIPTION

Now referring to the drawing, in which like reference numbers refer to like elements throughout, FIG. 2 shows one embodiment of the present invention with TEC 201 and TEC 202 mounted on the two opposite sidewalls of the package box 204. In this embodiment, the electrical leads 203 are on the front (the side with optical connector 205 designated as front side here) and back sides of the package body. Then, the sidewalls act as the heat sinks of the TECs. Of course, the package box can be modified to embody different configuration. For example, to extend the length of the box, the electrical leads can be set on the same sides of the TECs, as shown in FIG. 6 and the box may have two optical connectors, on which one is for optical input and other one is for optical output, for example.

The package box 204 is generally rectangular body having a rectangular opening and comprises four vertical sidewalls with an open or close bottom to accommodate components, such as TEC(s), platform 302, laser 401 (shown in FIG. 4), and other components. The package box 204 may be formed from any material suitable for housing an opto-electronic device using any suitable manufacturing method. For example, material for body 204 may be chosen for good thermal stability, high thermal conductivity for dispersing heat from TEC, mechanical strength, low permeability, good hermetic sealing properties, and machinability. The box 204 may be formed using manufacturing methods such as molding, machining, electron discharge machining, and the like. Mounting tabs extend from the bottom of the box 204, which are generally flat extensions having mounting holes therein to receive mounting hardware, such as crews for mounting package to, for example, circuit board (not shown).

An optical connector 205 extends from the front side of the box 204 for carrying an optical signal to a location external the package. Optical connector 205 may be any connector appropriate for terminating a fiber optic cable to receive an optical signal, as shown in the art.

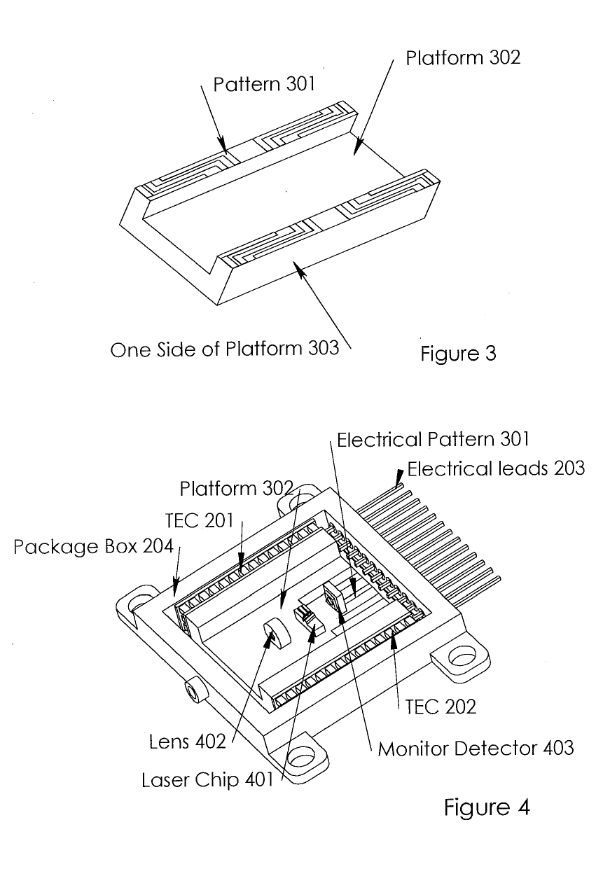

FIG. 3 shows a platform 302. It consists of ceramic material, such as aluminum nitride and silicon carbide or metal, such as kovar, with good thermal conduction and low thermal expansion coefficient. To facilitate the electrical connection and mounting components on it, the platform may have connection pattern 301 on it by, for example, screen-printing refractory metal paste on the alumina platform, and mounting marks (not shown).

The platform 302 has two thick shoulders. The two thick shoulders facilitate the attachment of the sides 303 and 304 of the platform to the top of the TEC 201 and 202. The shown platform is just for example. The platform may take different shape.

FIG. 4 illustrates a low profile package of a laser diode with the shown platform. The output fiber (not shown) is assumed to accepted a collimated beam. The collimating lens 402 collimates the beam from the laser diode 401 and the beam is usually parallel to the platform 302. Here, the package box shows an open bottom. During the packaging, for example, the platform 302 sits on a XYZ and tilting stage (not shown). The laser diode 401 and the lens 402 can be moved laterally. And by moving and tilting the platform 302 up and down, shifting the laser chip 401 and the lens 402 laterally, the output power from the fiber can be maximized. After alignment, all components are fixed on site. The height of the package is about the height of the lens 402 (or any component on the platform with the highest height) and the thickness of the platform 302. There may be some other components disposed on the platform, such as thermistor and optical isolator (not shown).

In FIG. 4, one pair TEC is used. It can be designed to use two or more pairs of TECs and two or more platforms. Then, the temperature of each platform can be set independently. And each platform moves independently. If one platform does not need active temperature control, the platform can be directly attached to the sidewalls of the package box or forms part of the bottom of the package.

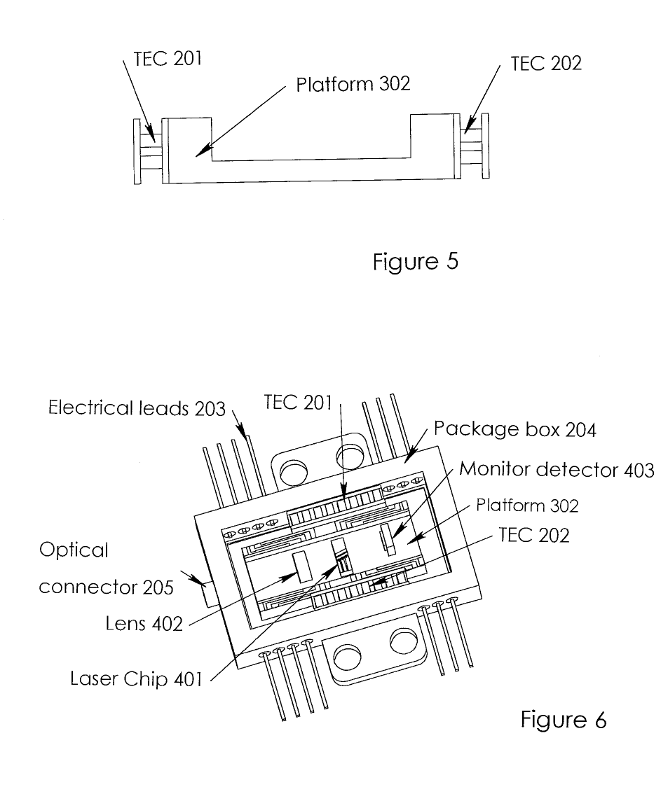

FIG. 5 shows the section view of the bonded platform and the TECs (other components not shown). The bondage is by applying epoxy or solder or other proper method.

FIG. 6 illustrates another laser diode package. The electrical leads are on the same sides of the TEC. The length of the TEC is short. The platform 601 is little different from the one illustrated in FIG. 4. The platform 601 also has thick shoulders with pattern on them to facilitate the wire bonding, if the platform is made of electrical isolating material. If the platform is made of electrical conduction material, such as kovar, some electrical rail (not shown here) made of electrical isolating material can be used for easy wire bonding.

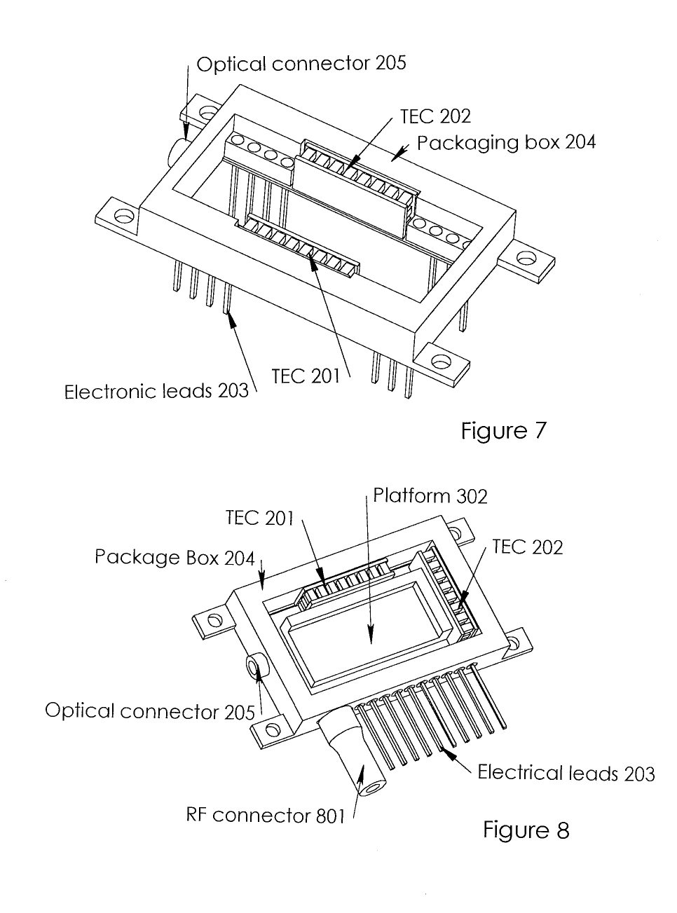

FIG. 7 illustrates a dual in-line package box, which has an electrical leads 203 on the bottom of the box. The optical connector 205 is on its front side. Two TECs 201 and 202 are bonded to two opposite sides of the package box. FIG. 8 shows a modified butterfly package that has electrical leads 203 on its one sidewall and two TEC 201 and 202 mounted on other two adjacent sidewalls. A radio frequency connector 801 is mounted on the same side of the electrical leads 203 for high frequency connection, such as high speed detection and high speed modulation. The platform, on which optical components and opto-mechanic fixtures can be disposed(not shown), has a L-shape shoulder. And its two thick sides are attached to the two tops of the TEC 201 and 202. In the exemplary embodiments, two TECs are preferred. If one TEC is used, it is mounted on the one sidewall of the package box and one side of platform is attached to the top of the TEC. The optical output from the laser diode to the optical fiber can be realized in various ways as described in the art, for example, using a collimating lens to collimate the optical output from the laser diode and a lens attached on the sidewall to focus the collimated beam into the fiber.

While the present invention is described with illustrations, it is to be understood that the invention is not limited to that described above. To the contrary, the invention is intended to cover various modifications and equivalent arrangements within the spirit and scope of the appended claims.

1. A package and method for packaging optoelectric devices, comprising:
a generally rectangular package body comprising four sidewalls;
one or more than one thermal electrical cooler;
one or more than one platform on which opto-electronic devices and components to be disposed;
attaching the said thermal electrical cooler(s) on the sidewall(s) of the package box by applying epoxy or solder;
attaching the side(s) of the said platform(s) to the top of the thermal electrical coolers.

2. The package and method of claim 1, wherein the package body has one or more than optical connector on its sidewall(s).

3. The package and method of claim 1, wherein the package body has a top defining a generally rectangular opening and a closed bottom.

4. The package body of claim 3 further comprising a lid hermetically scaled to the top of the package, the lid being free of connectors, leads, and mounting tabs.

5. The package and method of claim 1, wherein the package box defining one generally rectangular top opening and another generally rectangular bottom opening.

6. The package body of claim 5 further comprising a top lid and a bottom lid hermetically scaled to the top and the bottom of the box, the top and bottom lids being free of connectors, leads, and mounting tabs.

7. The package and method of claim 1, wherein the package box is dual in-line package, in which a plurality of electronic leads extend the bottom of the said package.

8. The package and method of claim 1, wherein the package box is butterfly box, in which a plurality of electronic leads extend one or more than one sidewall of the said package.

9. The package and method of claim 1, wherein the thermal electrical cooler has a top plate and bottom plate and semiconductor elements sandwiched between the said top and bottom plates.

10. The package and method of claim 1, wherein the package body has no or one or more than one radio-frequency connector on its sidewall(s) for high frequency connection to or from the component(s) inside the box.
